(19) United States
(12) Patent Application Publication
(10) Pub. No.: US 2025/0133268 A1
(43) Pub. Date: Apr. 24, 2025

(54) METHOD AND SYSTEM FOR ACCESSING REMOTE RESOURCES AND SERVICES FROM AUDIOVISUAL CONTENT

(71) Applicant: Skoleom Platform SAS, Palaiseau (FR)

(72) Inventors: Arnaud Gokou, Evry-Courcouronnes (FR); Kevin Racois, Saint Fargeau Ponthierry (FR)

(21) Appl. No.: 18/835,411

(22) PCT Filed: Feb. 2, 2023
(86) PCT No.: PCT/EP2023/052608

§ 371 Date: Aug. 2, 2024

(30) Foreign Application Priority Data
Feb. 4, 2022 (FR) FR2201013

(51) Int. Cl. H04N 21/4725; H04N 21/478

(52) U.S. Cl. CPC H04N 21/4725; H04N 21/47815

(57) ABSTRACT

A method is used for accessing remote resources and services from video content viewed on the screen of an electronic device held by a user, the video content having been previously enriched from initial content with additional information and/or services previously embedded in the video stream, which additional information and/or services are accessible in response to the user selecting an element of the initial video content being viewed, the additional information and/or services being displayed inside the video content.

### CROSS-REFERENCE TO RELATED APPLICATIONS

This application is a national phase entry under 35 U.S.C. § 371 of International Patent Application PCT/EP2023/052608, filed Feb. 2, 2023, designating the United States of America and published as International Patent Publication WO 2023/148295 Al on Aug. 10, 2023, which claims the benefit under Article 8 of the Patent Cooperation Treaty of French Patent Application Serial No. FR2201013, filed Feb. 4, 2022.

### TECHNICAL FIELD

The present disclosure relates to a method for accessing remote resources and services from audiovisual content. It also relates to a system implementing this method.

The field of the present disclosure includes digital communications, digital marketing, video and e-commerce.

### BACKGROUND

Steep growth is currently being observed in audiovisual content offerings. More and more of this audiovisual content is associated with brands and commercial offers.

Today, if someone viewing one such audiovisual content wishes to purchase a product or service seen therein, they must be redirected, via a digital communication network, to a sales site on the Web and use a payment tool. Examples include “Click and Buy®” and “Google Ads®”.

The disadvantage of current methods is that they do not give users real-time access to product or service purchasing services.

One of the main aims of the present disclosure is to remedy this drawback by proposing an innovative method of accessing purchasing resources and services from audiovisual content, without the need to be redirected to a purchasing site or a site providing additional information.

### BRIEF SUMMARY

This objective is achieved with a method for accessing remote resources and services from video content viewed on the screen of an electronic device held by a user, the video content having been previously enriched from initial content with additional information and/or services previously embedded in the video stream, which additional information and/or services are accessible in response to the user selecting an element of the initial video content being viewed, the additional information and/or additional services being displayed inside the video content.

The access method according to the present disclosure may advantageously comprise the following steps:
detecting a selection, by a user of an electronic communication equipment provided with a touch screen designed for watching this enriched video content, of an element within the video stream being displayed on this screen,
in response to this element selection detection, generating on the screen of an icon representative of a capsule associated with the selected element, this capsule being designed to contain information and/or services associated with the selected element,
detecting a user selection of the capsule icon,
in response to this icon selection detection, a window displaying one or more options to access information and/or services,
detecting the user selection of information and/or a service offered in the window, and
in response to this information and/or service selection detection, displaying the selected information and/or service within the video content currently being viewed.

The window displayed in response to a capsule icon selection detection may include a zone for selecting an additional video related to the selected element, and/or a zone for selecting an online store, and/or a zone for selecting a searchable document related to the selected element, for example, a press article.

The video content used by the access method according to the present disclosure has preferably been enriched using artificial intelligence techniques.

The capsules contained in the enriched video content have advantageously been created from a prior selection of elements in the initial video content and a search for information and/or services associated with these selected and classified elements.

Thus, with the access method according to the present disclosure, it becomes possible to provide a new purchasing experience for people viewing audiovisual content.

### BRIEF DESCRIPTION OF THE DRAWINGS

Embodiments of the present disclosure will be better understood in view of the figures, in which:

FIG. 1 shows the first four steps of an example of the access method according to the present disclosure; and

FIG. 2 shows three further steps in the exemplary embodiment shown in FIG. 1.

### DETAILED DESCRIPTION

### Definitions

API: for Application Programming Interface: application programming interface comprising a set of definitions and protocols that facilitate the creation and integration of application software.

SAAS: for Software as a Service: an application software solution hosted in the cloud and operated outside the organization or company by a third party, also known as a service provider. The SaaS solution is accessible on demand via an Internet connection.

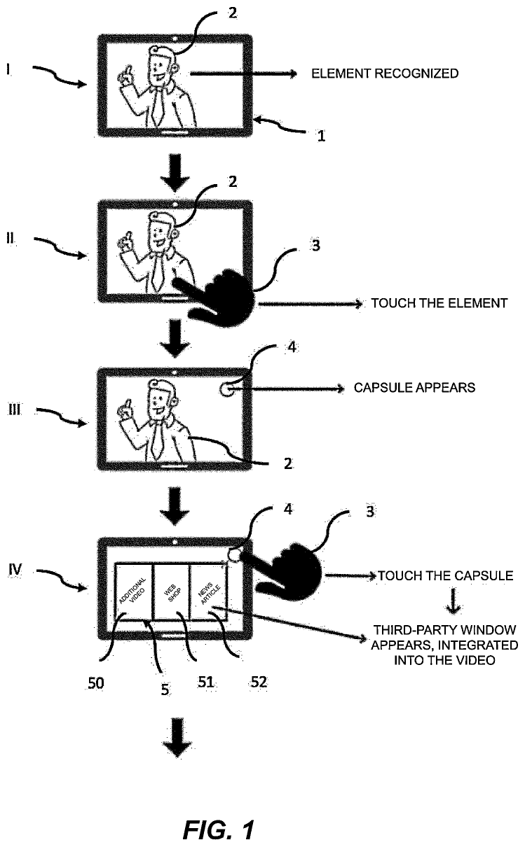

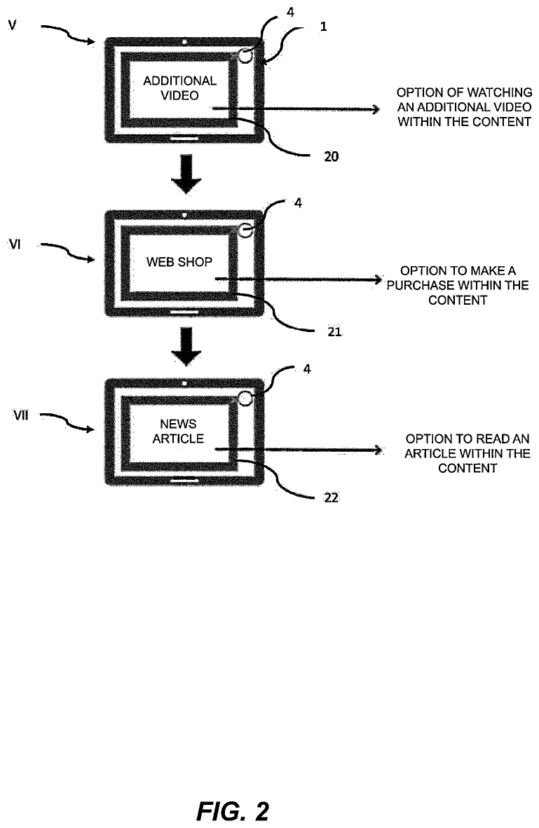

With reference to FIGS. 1 and 2, an example of the use of enriched video content by a person viewing or consulting this content on electronic communication equipment 1, such as a smartphone, tablet or personal computer, will be described.

In a first step I, the person consults the video content and locates an element, such as a known actor 2. In a second step II, the person then selects this element 2 by touching the screen 1 with a finger of their hand 3.

In a third step III, this selection causes a capsule icon 4 to be displayed in a corner of screen 1, for example, the top right-hand corner.

The person then selects (step IV) this capsule icon 4, which causes a window 5 to appear on screen 1, integrated into the video, this window 5 comprising three zones 50, 51, 52 corresponding respectively to an additional video, an online store and a press article, these three resources all being related to the selected element 2.

Therefore, if the user selects (step V) the zone 50, a window 20 for viewing an additional video appears and the user can directly watch this additional video within the enriched video content.

If the user selects the zone 51 (step VI), an online store 21 appears, integrated within the enriched video content.

If the user selects the zone 52 (step VII), a window 22 for reading a news article appears, integrated within the enriched video content.

How enriched audiovisual or video content can be produced by content creators will now be described. A production platform integrating a specific video player and implementing artificial intelligence algorithms can be made available to them in the form of an SAAS application. This platform enables the embedding of brands that a creator would like to see integrated into your audiovisual content.

The video player used in the method according to the present disclosure may have the following features:
product/service recognition: Artificial intelligence can recognize products and services embedded in the video,
people recognition: Artificial intelligence can recognize all the people in the video content,
location recognition: Artificial intelligence can recognize most similar locations in the video and give a precise address in the form of a geolocation (GPS),
object, plant and animal recognition: Artificial intelligence can recognize most types of objects, plants and animals in the video,
date recognition: Artificial intelligence can recognize a specific date (most),
analysis of the clothes worn by the protagonists, types of objects, etc., and
food and beverage recognition: Artificial intelligence can recognize a dish and its ingredients, and extract the ingredients of the dish.

### Classification of Elements and Capsules

The enrichment method implemented in this SAAS platform is designed to classify the capsules created as a result of the recognition process. Artificial intelligence will classify all recognized elements in a capsule integrated into the top right-hand corner of a video. It will then deduce three offers for the element:
an additional video: this video is extracted from the YouTube catalog or other videos from a public API, the closest one to the product for sale being integrated into the capsule. This additional content can be a report, a promotional video or a tutorial video;
an offer to buy a product or service: this product or service can be sourced from millions of products available on partners' international marketplaces;
an article: an article describing the product is automatically generated by artificial intelligence from information available on websites.

The texts describing these offers can be translated into several languages simultaneously.

For product recognition, artificial intelligence selects products available on e-commerce platforms worldwide. If the products are not recognized on one of the platforms, the artificial intelligence then sends a “product to be created” message to the product creation department, which will create the product in question: dimensions, colors, materials, etc.

The artificial intelligence is designed to perform the following operations:
“cut out” the product from the video content to extract a photo,
put it on a white background, extract a 3D video rotating on a white background,
assign it a sales price after benchmarking similar products internationally, automatically launch the product's production machine in a production plant,
reference the inventory available in the video content, and
publish the product in online video stores and make it available to the public.

### Examples of Capsules

Numerous types of capsule can be envisaged. The following is a non-exhaustive list of capsules that can be created as a result of the method for recognition in video content.
1. PEOPLE
2. LOCATION
3. EVENT
4. OBJECTS
5. PLANTS
6. ANIMALS
7. COSMETICS
8. GAMES
9. SPIRITUALITY & RELIGION
10. PERSONAL DEVELOPMENT
11. DATE
12. FOOD AND BEVERAGES
13. CLOTHING AND ACCESSORIES
14. CARS AND ACCESSORIES
15. FURNITURE
16. CONTESTS
17. REAL ESTATE
18. BEAUTY
19. TRAVEL
20. VOTING
21. MUSIC
22. ANIMATION
23. CHILDREN
24. TECH
25. BOOKS
26. BANKING
27. SCIENCE
28. EDUCATION
29. TRAINING
30. METHODS
31. GOVERNMENT

As a non-limiting example, 200 capsules for a 3-minute video, 600 capsules for a 6-minute video and over 1000 capsules for a video longer than 6 minutes may be contemplated.

The user of the enrichment method according to the present disclosure integrates video content in the form of a file or link into the Web platform or SAAS application.

The artificial intelligence then processes the video content over a period of time equal to or less than the duration of the video content, depending on the availability of the queue for this process, referencing all the information in a dashboard assigned to the user.

Of course, the present disclosure is not limited to the examples that have just been described, and many other embodiments may be envisaged without departing from the scope of this invention. In particular, the number of recognizable elements and capsules that can be integrated into enriched video content is only limited by the capacity and power of the computer servers used.

1. A method for accessing remote resources and services from video content viewed on the screen of an electronic device held by a user, the video content having been previously enriched from initial content with additional information and/or services previously embedded in a video stream, which additional information and/or services are accessible in response to the user selecting an element of the initial video content being viewed, the additional information and/or services being displayed inside the video content, the method comprising:
detecting a selection, by the user of an electronic communication equipment provided with a touch screen designed for watching enriched video content, of the element within the video stream being displayed on this screen;
in response to the detecting of the selection of the element, generating on the screen of an icon representative of a capsule associated with the selected element, the capsule containing information and/or services associated with the selected element;
detecting a user selection of the capsule icon:
in response to the detecting of the user selection of the capsule icon, displaying a window on the touch screen showing one or more options to access information and/or services;
detecting a user selection of information and/or a service offered in the window; and
in response to the detecting of the user selection of information and/or the service offered, displaying the selected information and/or service within the video content currently being viewed.

2. The method claim 1, wherein the window displayed in response to the detecting of the user selection of the capsule icon comprises a zone for selection of an additional video related to the selected element.

3. The method of claim 2, wherein the window displayed in response to the detecting of the user selection of the capsule icon comprises an online store selection zone.

4. The method according to of claim 3, wherein the window displayed in response to the detecting of the user selection of the capsule icon comprises a zone for selecting a viewable document related to the selected element.

5. The method according to claim 4, wherein the video content used by the method has been enriched by artificial intelligence.

6. The of claim 5, further comprising creating the capsules contained in the enriched video content from a prior selection of elements in the initial video content and a search for information and/or services associated with the priorly selected elements.

7. A platform for producing video capsules used in the access method according to claim 1, incorporating a video player designed to perform a process for recognizing products/services and/or persons and/or locations and implementing artificial intelligence algorithms.

8. The production platform of claim 7, designed to be accessible to service operators in the form of a service as a software application.

9. The production platform according to claim 8, wherein the production platform implements an enrichment method classifying capsules created at an end of a recognition process.

10. The method of claim 1, wherein the window displayed in response to the detecting of the user selection of the capsule icon comprises an online store selection zone.

11. The method of claim 1, wherein the window displayed in response to the detecting of the user selection of the capsule icon comprises a zone for selecting a viewable document related to the selected element.

12. The method according to claim 1, wherein the video content used by the method has been enriched by artificial intelligence.

13. The of claim 12, further comprising creating the capsules contained in the enriched video content from a prior selection of elements in the initial video content and a search for information and/or services associated with the priorly selected elements.
